(19) United States
(12) Patent Application Publication
(10) Pub. No.: US 2017/0341036 A1
(43) Pub. Date: Nov. 30, 2017

(54) IMPROVED METHOD FOR SYNTHESIS OF POLYAMIDE COMPOSITE MEMBRANES

(71) Applicant: Katholieke Universiteit Leuven, Leuven (BE)

(72) Inventors: Hanne Mariën, Dessel (BE); Ivo Vankelecom, Oud-Heverlee (BE); Sanne Hermans, Mechelen (BE)

(73) Assignee: Katholieke Universiteit Leuven, Leuven (BE)

(21) Appl. No.: 15/523,972

(22) PCT Filed: Nov. 4, 2015
(86) PCT No.: PCT/BE2015/000064

§ 371 Date: May 3, 2017

(30) Foreign Application Priority Data
Nov. 4, 2014 (GB) 1419605.9

(51) Int. Cl. B01D 71/56; C08F 2/04; B01D 69/12; C08G 69/28; B01D 61/02

(52) U.S. Cl. CPC B01D 71/56; C08G 69/28; B01D 61/027; B01D 69/125; C08F 2/04

(57) ABSTRACT

The present invention provides a method for the preparation of thin film composite (TFC) membranes, preferably solvent resistant TFC membranes, by interracial polymerization (IFP), more in particular solvent resistant TFC membranes wherein a thin PA-layer is deposited on a porous support membrane. Said method comprises the replacement of the aqueous and/or the organic solvent in the IFP method by an ionic liquid (IL) as solvent for the monomers which form said TFC membranes, to alter the top layer morphology, thickness and crosslinking degree.

### FIELD OF THE INVENTION

The present invention relates to a method for the preparation of thin film composite (TFC) membranes, preferably solvent resistant TFC membranes, by interfacial polymerization (IFP), wherein a thin polyamide-layer is deposited on a porous support membrane. More particularly, the IFP method of the present invention relates to the use of ionic liquids (ILs) as solvents for at least one type of monomer which forms said TFC membranes.

### BACKGROUND OF THE INVENTION

Membranes are used in separation processes as selective barriers that allow certain components to pass, i.e., the permeate, while retaining other compounds, i.e., the retentate. Selectivity is based on differences in size, charge, and/or affinity between the components and the membrane. Membrane separation processes are an increasingly important field in the art of separation science. They can be applied in the separation of a range of components of varying molecular weights in gas or liquid phases, including but not limited to nanofiltration (NF), desalination and water treatment (Mulder, M. Basic Principles of Membrane Technology, Second Edition. Dordrecht, Kluwer Academic Publishers, 1996. 564p). The main advantage of membrane technology is its environmentally friendly character, since it uses much less energy than most conventional separation technologies, like e.g. distillation, and causes less waste streams than e.g. extraction.

Membrane separation processes are widely applied in the filtration of aqueous fluids (e.g. desalination and wastewater treatment). However, they have not been widely applied for the separation of solutes in organic solvents, despite the fact that organic filtrations, such as organic solvent nanofiltration (OSN), have many potential applications in industry. This is mainly due to the relatively poor performance and/or stability of the membranes in organic solvents.

Many membranes for aqueous applications (e.g. desalination, NF) are thin film composite (TFC) membranes, which can be made by interfacial polymerization (IFP). The IFP technique is well known to those skilled in the art (Petersen, R. J. “Composite reverse osmosis and nanofiltration membranes”. J. Membr. Sci, 83, 81-150, 1993). In this technique, an aqueous solution of a reactive monomer (often a polyamine (e.g. a diamine)) is first deposited in the pores of a microporous support membrane (e.g. a polysufone ultrafiltration membrane)—this step is also referred to as support membrane impregnation. Then, the porous support membrane loaded with the first monomer is immersed in a water-immiscible, organic solvent solution containing a second reactive monomer (e.g. a tri- or diacid chloride). The two monomers react at the interface of the two immiscible solvents in the reaction zone, which is slightly shifted to the organic phase due to differences in partition coefficients of the monomers in the two solvents. The reaction proceeds until the film causes a diffusion barrier and the reaction is completed to form a highly crosslinked thin film layer that remains attached to the support membrane. Since membranes synthesized via this technique usually have a very thin top layer, high solvent permeances are expected.

After a first success reached by Loeb and Sourirajan on the synthesis of asymmetric reverse osmosis (RO) membranes, extensive research has been performed, starting from their RO membranes disclosed in U.S. Pat. No. 3,133,132. A subsequent breakthrough was achieved by Cadotte. Inspired by the work of Morgan, who was the first to describe “interfacial polymerization”, Cadotte produced extremely thin films using the knowledge about interfacial polymerization, as claimed in U.S. Pat. No. 4,277,344.

In the prior art, TFC membrane preparation by IFP comprises several steps: support membrane solidification (e.g. by phase inversion), support membrane impregnation with the first monomer and the IFP reaction itself. In case of crosslinked support membranes (for use in e.g. solvent resistant applications) an additional crosslinking reaction step (with e.g. multifunctional amines) is required. These multiple steps make TFC membrane preparation by IFP a time-consuming process. PCT/BE2013/000047 describes a new, simplified preparation method to obtain TFC membranes via IFP, in which support membrane solidification and support membrane impregnation with the first monomer are combined in one step. In the preparation of solvent resistant TFC membranes, three steps are combined: the two aforementioned steps together with the support membrane crosslinking. This is performed by dissolving the first monomer and the crosslinker in the coagulation medium prior to the phase inversion of the support membrane.

The thin film can be from several tens of nanometers to several micrometers thick. The thin film is selective between molecules, and this selective layer can be optimized for solute rejection and solvent flux by controlling the coating conditions and characteristics of the reactive monomers. Numerous condensation reactions can be used to make polymers via interfacial polymerization. Among the products of these condensation reactions are polyamides, polyureas, polyurethanes, polysulfonamides and polyesters. A particularly preferred class of TFC membranes, well known in the art, are polyamide (PA) TFC membranes whereby PAs are formed by IFP on the surface of a porous support membrane.

U.S. Pat. No. 5,246,587 describes an aromatic PA RO membrane that is made by first coating a porous support material with an aqueous solution containing a polyamine reactant and an amine salt. Examples of suitable polyamine reactants provided include aromatic primary diamines (such as, m-phenylenediamine or p-phenylenediamine or substituted derivatives thereof, wherein the substituent is an alkyl group, an alkoxy group, a hydroxy alkyl group, a hydroxy group or a halogen atom; aromatic secondary diamines (such as, N,N-diphenylethylene diamine), cycloaliphatic primary diamines (such as cyclohexane diamine), cycloaliphatic secondary diamines (such as, piperazine or trimethylene dipiperidine); and xylene diamines (such as m-xylene diamine). The organic solution contains an amine-reactive multifunctional acyl halide.

TFC membranes formed by IFP are often used for NF or reversed RO applications. NF applications have gained attention based on the relatively low operating pressures, high fluxes and low operation and maintenance costs associated therewith. NF is a membrane process utilizing membranes of molecular weight cut-off in the range of 200-2,000 Daltons. NF has been widely applied to filtration of aqueous fluids, but due to a lack of suitable solvent stable membranes, it has not been widely applied to the separation of solutes in organic solvents. This is despite the fact that OSN has many potential applications in manufacturing industry including solvent exchange, catalyst recovery and recycling, purifications, and concentrations.

Many different microporous support membranes can be chosen. Specific physical and chemical characteristics to be considered when selecting a suitable support membrane include: porosity, surface porosity, pore size distribution of surface and bulk, permeability, solvent resistance, hydrophilicity, flexibility and mechanical strength. Pore size distribution and overall porosity of the surface pores are of great importance when preparing a support for IFP. The support membranes generally used for commercial TFC membranes are often polysulfone (PSf) or polyethersulfone (PES) ultrafiltration membranes. These supports have limited stability in organic solvents and, therefore, TFC membranes of the prior art which are fabricated with such supports cannot be effectively utilized for all OSN applications. WO2012010889 describes NF TFC membranes formed by IFP on a support membrane, made from e.g. crosslinked polyimide, wherein said support membrane is further impregnated with a conditioning agent and is stable in polar aprotic solvents. U.S. Pat. No. 5,173,191 suggests nylon, cellulose, polyester, Teflon and polypropylene as organic solvent resistant supports. U.S. Pat. No. 6,986,844 proposes the use of crosslinked polybenzimidazole for making suitable support membranes for TFC. However, there remains a need for solvent resistant membranes having good filtration properties (high permeance & selectivity). It is an objective of the present invention to provide a route for the production of such membranes.

Many different additives can be added to the aqueous or the organic phase. Additives which are commonly used in TFC membrane synthesis are surfactants, acylation catalysts and phase transfer catalysts. Surfactants are added to the aqueous phase to improve the wettability of the support layer. They also decrease the surface tension at the interface, which improves the diffusion of monomers across the interface. Many possible surfactants exist, e.g. sodium dodecyl sulfate, dodecyltrimethylammonium bromide, polyethylene glycol, polyvinyl alcohol and ionic liquids. Acylation catalysts accelerate the reaction between the monomers, e.g. by removing hydrogen chloride in polyamide synthesis. Examples are sodium hydroxide, trisodium phosphate, dimethylpiperazine and triethylamine. The addition of phase transfer catalysts improves the diffusion of monomers across the interface by ion pairing with the monomers. Again, many possible phase transfer catalysts exist, e.g. tetraalkylammonium halides and phospates, tetraalkylphosphonium halides and other ionic liquids. Yung (“Fabrication of thin-film nanofibrous composite membranes by interfacial polymerization using ionic liquids as additives”. J. Membr. Sci, 365, 52-58, 2010) describes the possibility of using ionic liquids as surfactants or phase transfer catalysts in interfacial polymerization, which respectively cause an increase in permeance and decrease in selectivity or a decrease in permeance and increase in selectivity. This is achieved by adding very low concentrations (<2.5 wt %) of ionic liquids to the aqueous phase.

### SUMMARY OF THE INVENTION

The present invention provides a method for the preparation of thin film composite (TFC) membranes, preferably solvent resistant TFC membranes, by interfacial polymerization (IFP), wherein a thin PA-layer is deposited on a porous support membrane. More particularly, the present invention relates to the replacement of the aqueous and/or the organic solvent in the IFP method by an ionic liquid (IL) as solvent for the monomers which form said TFC membranes.

More particularly, in a first object the present invention provides a method for preparing a thin film composite membrane having a top layer comprising a polyamide film, wherein said method comprises the steps of
i. providing a porous support membrane impregnated with a first solvent comprising either solubilized multifunctional amines or solubilized acyl halides;
ii. contacting said impregnated support with a second solvent, which is immiscible with said first solvent and which comprises either (a) solubilized multifunctional amines in case said first solvent comprises acyl halides or (b) solubilized acyl halides in case said first solvent comprises multifunctional amines, whereby the multifunctional amines and acyl halides interfacially polymerize to form said polyamide film.

The method of the present invention being characterized in that said first or said second solvent is an ionic liquid or in that said first and second solvent are immiscible ionic liquids.

In a first embodiment of the method according to the present invention said first solvent is an aqueous solvent preferably comprising solubilized multifunctional amines and said second solvent is an ionic liquid preferably comprising solubilized acyl halides.

In a second embodiment of the method according to the present invention said first solvent is an ionic liquid preferably comprising solubilized multifunctional amines and said second solvent is an organic solvent or an ionic liquid preferably comprising solubilized acyl halides.

It is a second object of the present invention to provide a thin film composite membrane prepared according to the method according to the present invention.

In a third object the use of the thin film composite membranes prepared according to the method of the present invention is provided for the nanofiltration of components wherein said components are contained in water, organic solvents or polar aprotic solvents.

### DESCRIPTION

The present invention provides a method for the preparation of thin film composite (TFC) membranes, preferably solvent resistant TFC membranes, by interfacial polymerization (IFP), wherein a thin PA-layer is deposited on a porous support membrane. More particularly, the present invention relates to the replacement of the aqueous and/or the organic solvent in the IFP method by an ionic liquid (IL) as solvent for the monomers which form said TFC membranes.

The scope of the applicability of the present invention will become apparent from the detailed description and drawings provided herein. However, it should be understood that the detailed description and specific examples, while indicating preferred embodiments of the present invention, are given by way of illustration only since various changes and modifications within the spirit and scope of the invention will become apparent to those skilled in the art from this detailed description. Unless otherwise defined, all technical and scientific terms used herein have the same meaning as commonly understood by one of ordinary skill in the art to which this invention belongs.

The preparation of thin film composite membranes using interfacial polymerization is well known in the art. These preparation methods involve contacting a porous support membrane impregnated with a first solvent comprising preferably nucleophilic monomers, such as multifunctional amines, with a second solvent, which is immiscible with said first solvent, comprising preferably electrophilic monomers, such as acyl halides. Since two immiscible solvents are used an interface is formed along the surface of the support membrane contacting said second solvent at which the interfacial polymerization reaction between the nucleophilic and electrophilic monomers occurs. In the particular case wherein the electrophilic monomers are multifunctional acyl halides and the nucleophilic monomer are multifunctional amines, the interfacial polymerization reaction results in the formation of a thin polyamide film on said porous support membrane. The thin film composite membranes obtained using this interfacial polymerization method are typically used for separation of compounds using nanofiltration. In the context of the present invention it was surprisingly found that altering the methods of the art by replacing the first and/or second solvent with suitable ionic liquids resulted in the formation of thin film composite membranes with a polyamide top layer, which were particularly suitable for nanofiltration applications. Moreover, it was observed that the use of the ionic liquids allowed for preparing thin film composite membranes having a markedly higher permeance and a similar retention as compared to equivalent thin film composite membranes prepared using interfacial polymerization methods known in the art.

Therefore, in a first object the present invention provides a method for preparing a thin film composite membrane having a top layer comprising a polyamide film, wherein said method comprises the steps of
i. providing a porous support membrane impregnated with a first solvent comprising either solubilized multifunctional amines or solubilized acyl halides;
ii. contacting said impregnated support with a second solvent, which is immiscible with said first solvent and which comprises either (a) solubilized multifunctional amines in case said first solvent comprises acyl halides or (b) solubilized acyl halides in case said first solvent comprises multifunctional amines, whereby the multifunctional amines and acyl halides interfacially polymerize to form said polyamide film.

The method of the present invention being characterized in that in said first or said second solvent is an ionic liquid or in that said first and second solvent are immiscible ionic liquids.

Preferably, the first solvent used for impregnating the porous support membrane comprises solubilized multifunctional amines and said second solvent comprises acyl halides. Typically, in the method according to the present invention the said impregnated support membrane is contacted with said second solvent in step (ii) by bringing the surface of said membrane into contact with said second solvent.

The porous support membrane used in a method according to the present invention may comprise a crosslinked or non-crosslinked polymer depending on the anticipated use of the eventual thin film composite membrane.

Typically, the acyl halides used in a method according to the present invention are acyl chlorides, preferably diacyl chlorides or polyacyl chlorides, such as trimesoyl chloride. Furthermore, the multifunctional amines are preferably selected from the group comprising 1,2-diaminoethane, 1,3-diaminopropane, diaminobutane, diaminopentane, diaminohexane, diaminoheptane, diamino-octane, diaminononane, diaminodecane, ethylenediamine, N,N′-dimethylethylenediamine, N,N′-diethylethylenediamine, diethylenetriamine, triethylenetetraamine, tetraethylenepentaamine, pentaethylenehexamine, tris(2-aminoethyl)amine, polyethyleneimine, polyallylamine, polyvinylamine, polyether diamines based predominantly on a polyethylene oxide backbone with a molecular weight of 50 to 20,000, trimethoxysilylpropyl-substituted polyethyleneamine having a molecular weight of 1,000 to 200,000, m-xylylenediamine, p-xylylenediamine, multifunctional aniline derivatives, phenylenediamines, methylenedianiline, oxydianiline and analogues thereof.

In a first embodiment of the method according to the present invention said first solvent is an aqueous solvent preferably comprising solubilized multifunctional amines and said second solvent is an ionic liquid preferably comprising solubilized acyl halides. Preferably said second solvent is a hydrophobic, water immiscible ionic liquid, such as an ionic liquid comprising bis(trifluoromethylsulfonyl)imide or hexafluorophosphate as anion and an imidazolium, pyrridinium, pyrrolidinium and phosphonium cation as cation.

In a second embodiment of the method according to the present invention said first solvent is an ionic liquid preferably comprising solubilized multifunctional amines and said second solvent is an organic solvent or an ionic liquid preferably comprising solubilized acyl halides. Preferably, said first solvent is a hydrophilic, water miscible ionic liquid, such as an ionic liquid comprising acetate, alkyl sulfate, dialkyl phosphate or a halide as anion and an imidazolium, pyrridinium, pyrrolidinium and phosphonium cation as cation. In a particular embodiment of said second embodiment the second solvent is a hydrophobic, water immiscible ionic liquid, such as an ionic liquid comprising bis(trifluoromethylsulfonyl)imide or hexafluorophosphate as anion and an imidazolium, pyrridinium, pyrrolidinium and phosphonium cation as cation.

Typically, a thin film composite membrane prepared according to the method of the present invention is further processed before use, for instance as a nanofiltration membranes. Such further processing may involve rinsing or conditioning in different baths, respectively referred to as rinsing and conditioning baths. Optionally, the resulting membrane is further treated with an activating solvent.

It is a second object of the present invention to provide a thin film composite membrane prepared according to the method according to the present invention.

In a third object the use of the thin film composite membranes prepared according to the method of the present invention is provided for the nanofiltration of components wherein said components are contained in water, organic solvents or polar aprotic solvents.

In a particular embodiment of the first embodiment of the method of the present invention, preferably acyl halides, more preferably multifunctional acyl chlorides are dissolved in an IL prior to IFP. A porous support membrane, impregnated with a solution comprising preferably an aqueous solvent containing preferably multifunctional amines, is brought into contact with said IL-solution. Since two immiscible solvents are used, an interface is formed at which the IFP reaction between the acyl halides or more particularly acid chlorides and the amines takes place.

Thus, this particular embodiment of the present invention provides a method for the preparation of TFC membranes via IFP, which can be described as follows:

(a) providing a porous support membrane impregnated with a first solvent, preferably an aqueous solvent, comprising the first reactive monomers. Preferably said reactive monomers are either solubilized multifunctional amines or solubilized acyl halides, more preferably multifunctional amines.
Said impregnated porous support membrane can be prepared by casting a polymer onto a supporting substrate and immersing said cast polymer film in a coagulation medium, preferably comprising said first reactive monomers and a first solvent for said first reactive monomer. The coagulation medium optionally contains a support membrane crosslinking compound in case a crosslinked support membrane is desired.
In case the coagulation medium doesn't comprise a first reactive monomer (nor an optional crosslinker), said impregnated porous support membrane can be obtained according to the following procedure:
   i. if a crosslinked support membrane is desired: immersing the solidified support membrane in a solvent exchange medium comprising a solvent in which the crosslinker is soluble and in which said support membrane swells, making all polymer chains accessible for said crosslinker;
   ii. if a crosslinked support membrane is desired: immersing said support membrane in a solution comprising the solvent used in (i) and a crosslinker;
   iii. impregnating the optionally crosslinked support membrane with a first reactive monomer solution comprising a solvent for the first reactive monomer and the first reactive monomers

(b) contacting the solidified, possibly crosslinked and impregnated support membrane with a second reactive monomer solution comprising an IL as solvent for the second reactive monomers and second reactive monomers, wherein the first and the second solvent form a two phase system. Typically, said second reactive monomers are solubilized multifunctional amines in case said first solvent comprises acyl halides. Alternatively, said second reactive monomers are solubilized acyl halides in case said first solvent comprises multifunctional amines.

Typically, the resulting membrane is further treated in different rinsing baths and/or conditioning baths. Optionally, the resulting membrane is treated with an activating solvent.

In a particular embodiment of the second embodiment of the method of the present invention, preferably multifunctional amines are dissolved in an IL and deposited in the pores of a porous support membrane. The impregnated porous support membrane is brought into contact with a solution (organic solvent or IL based) containing preferably acyl halides, preferably multifunctional acid chlorides. Since two immiscible solvents are used, an interface is formed at which the IFP reaction between the acid chlorides and the amines takes place.

Thus, this particular embodiment of the present invention provides a method for the preparation of TFC membranes via IFP, which can be described as follows:

(a) providing a porous support membrane impregnated with a first solvent, preferably an ionic liquid, comprising the first reactive monomers. Preferably said reactive monomers are either solubilized multifunctional amines or solubilized acyl halides, more preferably multifunctional amines.
Said impregnated porous support membrane can be prepared by casting a polymer onto a supporting substrate and immersing said cast polymer film in a coagulation medium. The coagulation medium optionally contains a support membrane crosslinking compound in case a crosslinked support membrane is desired. In case the coagulation medium doesn't comprise a crosslinking compound and a crosslinked support membrane is desired, following further steps have to be performed:
   i. immersing the solidified support membrane in a solvent exchange medium comprising a solvent in which the crosslinker is dissolvable and in which said support membrane swells, making all polymer chains accessible for said crosslinker;
   ii. immersing said support membrane in a solution comprising the solvent used in (i) and a crosslinker.
Once a solidified crosslinked or non-crosslinked support membrane is obtained, said membrane is impregnated with a solution comprising an IL as a first solvent for the first reactive monomers and first reactive monomers.

(b) contacting the impregnated support membrane with a second reactive monomers solution comprising a second solvent (organic solvent or IL) for the second reactive monomer and second reactive monomers, wherein the first and the second solvent form a two phase system. Typically, said second reactive monomers are solubilized multifunctional amines in case said first solvent comprises acyl halides. Alternatively, said second reactive monomers are solubilized acyl halides in case said first solvent comprises multifunctional amines.

Typically, the resulting membrane is further treated in different rinsing baths and/or conditioning baths. Optionally, the resulting membrane is treated with an activating solvent.

In both approaches, crosslinking of the support membrane results in a solvent resistant composite membrane. For use in aqueous applications, crosslinking is not required. In this case, no crosslinker has to be added in step (a), or steps (i) and (ii) don't have to be performed. Preferred embodiments of the present invention provides methods for obtaining PA/PSf and PA/polyimide (PI) TFC membranes (with a PA thin layer on a PSf or a possibly crosslinked PI membrane support), preferably comprising the one step synthesis, (crosslinking) and impregnation of crosslinked PI support membranes, preferably via a phase inversion process by immersion precipitation.

### Support Membrane Preparation

In the context of the present invention, support membrane preparation typically involves the following steps: (a) Preparing a polymer casting solution comprising (i) a membrane polymer, and preferably (ii) a water miscible solvent system for said polymer; (b) Casting a film of said casting solution onto a supporting substrate; (c) Immersing the film cast on the substrate into an aqueous coagulation medium, preferably containing a first reactive monomer and possibly a crosslinker, possibly after an evaporation step.

Suitable support membranes can be produced from polymer materials including PSf, PES, PI, polybenzimidazole, polyacrylonitrile, Teflon, polypropylene, and polyether ether ketone (PEEK), or sulfonated polyether ether ketone (S-PEEK). The polymer used to form the support membrane includes but is not limited to PSf and PI polymer sources.

The polymer casting solution may be prepared by dissolving the polymer making up the membrane in one or a mixture of organic solvents, including the following water miscible solvents: N-methylpyrrolidone (NMP), tetrahydrofuran (THF), N,N-dimethylformamide (DMF), N,N-dimethylacetamide (DMAc), dimethylsulfoxide (DMSO), 1,4-dioxane, gamme-butyrolactone, water, alcohols, ketones and formamide. The weight percent of the polymer in solution may range from 5% to 30% in the broadest sense, although a 12% to 28% range is preferable and an 12% to 24% range or 14% to 18% is even more preferred.

A porous support membrane for use in the method according to the present invention can be prepared as follows: a polymer casting solution is casted onto a suitable porous substrate, from which it then may be removed. Casting of the membrane may be performed by any number of casting procedures cited in the literature, for example U.S. Pat. No. 3,556,305; U.S. Pat. No. 3,567,810; U.S. Pat. No. 3,615,024; U.S. Pat. No. 4,029,582 and U.S. Pat. No. 4,188,354; GB-A-2,000,720; Office of Saline Water R & D Progress Report No. 357, October 1967; Reverse Osmosis and Synthetic Membranes, Ed. Sourirajan; Murari et al, J. Membr. Sci. 16: 121-135 and 181-193, 1983.

Alternatively, a porous support membrane for use in the method according to the present invention can be prepared as follows: once the desired polymer casting solution is prepared (i.e. polymers are dissolved in a suitable solvent system, and optionally organic or inorganic matrices are added into the casting solution so that the matrices are well dispersed) and, optionally, filtered by any of the known processes (e.g. pressure filtration through microporous filters, or by centrifugation), it is casted onto a suitable porous substrate, such as glass, metal, paper, plastic, etc., from which it may then be removed. Preferably, the desired polymer casting solution is casted onto a suitable porous substrate from which the membrane is not removed. Such porous substrate can take the form of an inert porous material which does not hinder the passage of permeate through the membrane and does not react with the membrane material, the polymer casting solution, the aqueous coagulation medium, or the solvents which will permeate through the membrane during filtration.

Such porous substrates may be non-woven, or woven, including cellulosics (paper), polyethylene, polypropylene, nylon, vinyl chloride homo-and co-polymers, polystyrene, polyesters such as polyethylene terephthalate, polyvinylidene fluoride, polytetrafluoroethylene, PSf, PES, poly-ether ketones (PEEK), polyphenylene oxide, polyphenyline sulphide (PPS), Ethylene-(R) ChloroTriFluoroEthylene (Halar® ECTFE), glass fibers, metal mesh, sintered metal, porous ceramic, sintered glass, porous carbon or carbon fibre material, graphite, inorganic membranes based on alumina and/or silica (possibly coated with zirconium and/or other oxides). The membrane may otherwise be formed as a hollow fiber or tubelet, not requiring a support for practical use; or the support may be of such shape, and the membrane is casted internally thereon.

### Ionic Liquids

ILs are organic salts consisting of positively and negatively charged ions that are liquid at ambient temperatures or below 100° C. ILs are considered as green solvents to replace organic solvents, mainly because of their extremely low vapour pressure, their non-explosivity and their ability to be recycled. In a membrane synthesis context, the advantages of most ILs over organic solvents are their ability to dissolve many compounds, their non-volatility and thermal stability and their immiscibility with many solvents. In addition, the solvent properties of ILs can be tuned for a specific application by varying the anion cation combinations (Keskin, S., et al. “A review of ionic liquids towards supercritical fluid applications”. J. Supercrit. Fluids, 43, 150-180, 2007). Further, ILs have the ability to alter/improve the reaction kinetics in polymer chemistry (Kubisa, P. “Ionic liquids as solvents for polymerization processes—Progress and challenges”. Prog. Polym. Sci, 34, 1333-1347, 2009).

In the context of the present invention, the ILs have to comply with certain properties. Firstly, their viscosity should be moderate so that they are manageable as a solvent. Secondly, they should be resistant to acid conditions since HCl is formed during IFP. In addition, the ILs should not react with the support membrane crosslinker and the two monomers used for the IFP reaction. Finally, the ILs should be chosen so that their polarity and miscibility properties induce the formation of a two-phase system.

In the first new approach disclosed in this patent, a multifunctional acid chloride is dissolved in an IL prior to IFP. A porous support membrane, impregnated with a solution comprising an aqueous solvent for the multifunctional amine and a multifunctional amine, is immersed with said IL-solution. In this case, the IL should be immiscible with the aqueous phase. Since the polarity of an IL is mainly determined by the anion, hydrophobic anions should be chosen. Examples hereof are the hexafluorophosphate (PF₆⁻) and the bis(trifluoromethylsulfonyl)imide (Tf₂N⁻) anions. A disadvantage of the former anion is its instability in the presence of water, whereby decomposition of the anion and formation of HF occurs. However, in the latter anion, the C—F bonds are inert to hydrolysis, so no HF formation takes place. Therefore, and because of its more hydrophobic character, it is advantageous to use the Tf₂N⁻ anion, which can be combined with a wide variety of cations. Common cations are based on e.g. imidazolium, pyridinium, phosphonium and pyrrolidinium, which are substituted with alkyl chains. Also a wide variety of alkyl chain lengths is possible. Preferred ILs are 1-butyl-3-methylimidazolium bis(trifluoromethylsulfonyl)imide and 1-butyl-1-methylpyrrolidinium bis(trifluoromethylsulfonyl)imide.

In the second new approach disclosed in this patent, a multifunctional amine is dissolved in an IL and deposited in the pores of a support layer. The impregnated support is immersed with a solution comprising a solvent (organic solvent or IL) for the multifunctional acid chloride and a multifunctional acid chloride. In this case, the IL which is used as a solvent for the multifunctional amine should be hydrophilic and immiscible with the other solvent. Many different hydrophilic anions can be chosen, e.g. alkyl sulfate, dialkyl phosphate, chloride and acetate. These anions can again be combined with the cations described in the previous paragraph. Preferred ILs are 1-ethyl-3-methylimidazolium ethyl sulfate and 1-ethyl-3-methylimidazolium acetate. It is also possible to use a mixture of water and IL as a solvent for the multifunctional amine. In this way, certain properties (e.g. viscosity and density) of the first phase can be altered. The second phase comprises a solvent for the multifunctional acid chloride and a multifunctional acid chloride. The solvent can be a hydrophobic organic solvent (e.g. hexane or toluene) or an IL. When using an IL as second phase, it has to meet the same properties which apply for the ILs described in the first new approach (previous paragraph), so these types of IL can also be used here.

### Interfacial Polymerization

The interfacial polymerization reaction is generally held to take place at or near the interface between the first reactive monomer solution and the second reactive monomer solution, which form two phases. Each phase may include a solution of a dissolved monomer or a combination thereof. Concentrations of the dissolved monomers may vary. Variables in the system may include, but are not limited to, the nature of the solvents, the nature of the monomers, monomer concentrations, use of additives in any of the phases, reaction temperature and reaction time. Such variables may be controlled to define the properties of the membrane, e.g., membrane selectivity, flux, top layer thickness. Monomers used in the reactive monomer solutions may include, but are not limited to, diamines and triacid chlorides. The resulting reaction may form a PA selective layer on top of the support membrane.

In the first new approach disclosed in this patent, a multifunctional acid chloride is dissolved in an IL prior to IFP. A porous support membrane, impregnated with a solution comprising an aqueous solvent for the multifunctional amine and a multifunctional amine, is immersed with said IL-solution. Since two immiscible solvents are used, an interface is formed at which the IFP reaction between the acid chloride and the amine takes place. As described in prior art when using an aqueous and an organic phase, the amine monomer diffuses out of the aqueous phase into the organic phase where the reaction with the acid chloride monomer takes place. Diffusion of the acid chloride in the other direction is much slower because of the lower solubility of the acid chloride in the aqueous phase. The reaction zone is thus slightly shifted to the organic phase. The replacement of the organic phase by an IL therefore has several impacts. Firstly, the higher viscosity of the IL in comparison with an organic solvent influences the diffusion velocity of the amine and the acid chloride monomers in this phase. Secondly, the solubility of the multifunctional amine in the IL is different compared to in an organic solvent. Further, the interfacial tension between the two phases is altered when replacing one of the solvents, which has an impact on the diffusion of the monomers across the interface. All these parameters have an influence on the final top layer morphology, thickness and crosslinking degree, which, in turn, determine the membrane performance (permeance an selectivity), as can be seen in the examples attached.

In the second new approach disclosed in this patent, a multifunctional amine is dissolved in an IL and deposited in the pores of a support layer. The impregnated support is immersed with a solution comprising a solvent (organic solvent or IL) for the multifunctional acid chloride and a multifunctional acid chloride. Since two immiscible solvents are used, an interface is formed at which the IFP reaction between the acid chloride and the amine takes place. Also the replacement of the aqueous phase by an IL has several impacts. Firstly, the ratio of the solubilities of both monomers in both phases determines the location of the reaction zone. Secondly, the interfacial tension between the two phases is altered when replacing the aqueous phase by an IL. In addition, when the aqueous phase is water, the acid chloride monomer, dissolved in the other phase, can become partially hydrolyzed at the interface, with a lower crosslinking degree as a result. This can be overcome by replacing water by an IL. All these parameters again have an influence on the final top layer morphology, thickness and crosslinking degree, which, in turn, determine the membrane performance (permeance an selectivity), as can be seen in the examples attached.

Treatment of the Resulting TFC Membrane with an Activating Solvent

In the method according to the present invention, the post-treatment step preferably includes treating the resulting TFC membranes prior to use for (nano)filtration with an activating solvent, including, but not limited to, polar aprotic solvents. In particular, activating solvents include DMAc, NMP, DMF and DMSO. The activating solvent as referred to herein is a liquid that enhances the TFC membrane flux after treatment. The choice of activating solvent depends on the top layer and membrane support stability. Contacting may be effected through any practical means, including passing the TFC membrane through a bath of the activating solvent, or filtering the activating solvent through the composite membrane.

More preferably, the composite membrane may be treated with an activating solvent during or after interfacial polymerization. Without wishing to be bound by any particular theory, the use of an activating solvent to treat the membrane is believed to flush out any debris and unreacted material from the pores of the membrane following the interfacial polymerization reaction. The treatment of the composite membrane with an activating solvent provides a membrane with improved properties, including, but not limited to, membrane flux.

### EXAMPLES

Abbreviations used:

PP (polypropylene); PE (polyethylene); PSf (polysulfone); PI (polyimide); NMP (N-methyl-2-pyrollidone); THF (tetrahydrofuran); MPD (m-phenylene diamine); HDA (hexane diamine); SDS (sodium dodecyl sulphate); TEA (triethylamine); TMC (trimesoylchloride); PA (polyamide); DMF (dimethylformamide); ACN (acetonitrile); BMIM Tf₂N (1-butyl-3-methylimidazolium bis(trifluoromethylsulfonyl)imide); BMPy Tf2N (1-butyl-1-methylpyrrolidinium bis(trifluoromethylsulfonyl)imide); EMIM EtSO₄ (1-ethyl-3-methylimidazolium ethylsulfate); EMIM Ac (1-ethyl-3-methylimidazolium acetate); RB (Rose Bengal); NaCl (sodium chloride); EtOH (ethanol).

The filtration performance (evaluated by the permeance and rejection properties of the membranes) is assessed by “dead-end” NF with the following feed solutions: 35 μM Rose RB in ethanol EtOH. The RB and MO concentration in feed and permeate is quantified by UV-VIS.

### Example 1

A polymer dope solution was prepared by dissolving 18 wt % PSf (Udel® P-1700, Solvay) in NMP (Acros) until complete dissolution. The viscous polymer solution was allowed to stand for several hours to remove air bubbles. The dope solution was then cast onto a porous non-woven PP/PE supporting substrate (Novatexx 2471, Freudenberg) with a casting speed of 0.044 m/s. The cast films were immersed in a coagulation medium for 5 min. The coagulation medium consisted of MPD dissolved in milliQ water, in which MPD acts as a multifunctional amine monomer for IFP. One film was immersed in a coagulation medium with a MPD-concentration of 2 wt %. This is the standard MPD-concentration for PA-membranes made via the traditional method with water and hexane as solvents for MPD and TMC respectively. Two other films were immersed in a coagulation medium with a MPD-concentration of 0.1 wt %.

After phase inversion of the support layer and impregnation with the amine monomer in the coagulation medium, TFC membranes were made on the first and second PSf support membrane through IFP. Therefore, the PSf support membrane was fixed on an inox plate and excess amine solution was removed with a rubber wiper. A glass frame was clamped (leakproof) on the PSf support membrane. A solution of 0.1 wt % TMC in BMIM Tf₂N was poured on the PSf support membrane which was impregnated with 2 wt % MPD. This is the standard TMC-concentration for PA-membranes made via the traditional method with water and hexane as solvents for MPD and TMC respectively. A solution of 0.5 wt % TMC in BMIM Tf₂N was poured on the PSf support membrane which was impregnated with 0.1 wt % MPD. After 1 min of reaction, the TMC solution was removed and the membrane was rinsed with ACN to remove residual TMC on the membrane surface. The resulting TFC membranes were stored in water until use. The last PSf support membrane was tested as such after storage in water.

The filtration characteristics after filtration with 35 μM RB in EtOH are summarized in Table 1.

TABLE 1

| | | | Permeance | |
|---|---|---|---|---|
| | | Pressure | (L(m² h | Retention |
| Nr. | Membrane | (bar) | bar)) | (%) |
| 1 | PSf support membrane | 0.5 | 218.99 | 7 |
| 2 | BMIM Tf₂N-2.0 wt % | | | |
| | MPD-0.1 wt % TMC | 0.5 | 215.39 | 3 |
| 3 | BMIM Tf₂N-0.1 wt % | | | |
| | MPD-0.5 wt % TMC | 30 | 0.53 | 94 |

It is clear that no top layer is formed on membrane 2, since it has a very similar permeance and retention compared to the PSf support membrane. This also indicates that contacting the PSf support membrane with BMIM Tf₂N has no influence on the density of the PSf support membrane, which can sometimes be the case (see example 6 and 7). However, a good top layer is formed on membrane 3.

### Example 2

TFC membranes were prepared exactly as described in example 1, with the only difference that IFP is performed with a solution of TMC in hexane.

The filtration characteristics after filtration with 35 μM RB in EtOH are summarized in Table 2.

TABLE 2

| | | | Permeance | |
|---|---|---|---|---|
| | | Pressure | (L(m² h | Retention |
| Nr. | Membrane | (bar) | bar)) | (%) |
| 1 | Hexane-2.0 wt % | 30 | 0.11 | 98 |
| | MPD-0.1 wt % TMC | | | |
| 2 | Hexane-0.1 wt % | 30 | 0.14 | 97 |
| | MPD-0.5 wt % TMC | | | |

When comparing the results of example 1 and example 2, it is clear that, when hexane is replaced by BMIM Tf₂N, the monomer concentrations play a more crucial role to create high-performant membranes (with a RB-retention >90%). Besides, when the membranes made with concentrations of 0.1 wt % MPD-0.5 wt % TMC are compared, the use of BMIM Tf₂N causes an increase in permeance (×4) of the high-performant membranes, while the retention only slightly decreases. This indicates that the properties of the IL have an big impact on the top layer morphology.

### Example 3

TFC membranes were prepared using the same method as described in example 1. The effect of adding the additives SDS and TEA to the aqueous phase was investigated, both for membranes made with hexane as with BMIM Tf₂N as a solvent for TMC (the organic solution). MPD, SDS and TEA were dissolved in milliQ water (the aqueous solution). The optimal MPD- and TMC-concentrations of examples 1 and 2 were used to create high-performant membranes. Table 3 shows the composition of the MPD- and TMC-solutions.

TABLE 3

| | | | | | Organic |
|---|---|---|---|---|---|
| | | Aqueous solution | | | solution |
| | | MPD- | SDS- | TEA- | TMC- |
| | | conc | conc | conc | conc |
| Nr. | Membrane | (wt %) | (wt %) | (wt %) | (wt %) |
| 1 | Hexane-no additives | 2 | — | — | 0.1 |
| 2 | Hexane-with SDS | 2 | 0.1 | — | 0.1 |
| 3 | Hexane-with TEA | 2 | — | 2 | 0.1 |
| 4 | Hexane with SDS and TEA | 2 | 0.1 | 2 | 0.1 |
| 5 | BMIM Tf₂N-no additives | 0.1 | — | — | 0.5 |
| 6 | BMIM Tf₂N-with SDS | 0.1 | 0.1 | — | 0.5 |
| 7 | BMIM Tf₂N-with TEA | 0.1 | — | 0.5 | 0.5 |
| 8 | BMIM Tf₂N-with SDS and | 0.1 | 0.1 | 0.5 | 0.5 |
| | TEA | | | | |

The filtration characteristics after filtration with 35 μM RB in EtOH are summarized in Table 4.

TABLE 4

| | | | Permeance | |
|---|---|---|---|---|
| | | Pressure | (L(m² h | Retention |
| Nr. | Membrane | (bar) | bar)) | (%) |
| 1 | Hexane-no additives | 30 | 0.11 | 98 |
| 2 | Hexane-with SDS | 30 | 0.22 | 98 |
| 3 | Hexane-with TEA | 30 | 0.15 | 93 |
| 4 | Hexane with SDS and TEA | 30 | 0.39 | 96 |
| 5 | BMIM Tf₂N-no additives | 30 | 0.53 | 94 |
| 6 | BMIM Tf₂N-with SDS | 30 | 0.57 | 94 |
| 7 | BMIM Tf₂N-with TEA | 30 | 0.67 | 94 |
| 8 | BMIM Tf₂N-with SDS and | 30 | 0.49 | 95 |
| | TEA | | | |

The additives SDS and TEA act in the IFP-reaction as a surfactant and as a base/catalyst respectively. The results show that using both additives increases the permeance (×3) in the traditional method with hexane. Although, when using BMIM Tf₂N as a solvent, the additives don't have a significant effect on the membrane performance.

### Example 4

Four membranes which showed a high performance during filtration with RB in EtOH were filtered with a feed solution of NaCl in milliQ-water. For BMIM Tf₂N as organic solvent, membranes made with monomer concentrations of 0.1 wt % MPD-0.5 wt % TMC with and without SDS and TEA were tested (membrane 5 and 8 of example 3). For hexane as organic solvent, membranes made with monomer concentrations of 2.0 wt % MPD-0.1 wt % TMC and 0.1 wt % MPD-0.5 wt % TMC were tested because they both had a high retention for RB. Here, only membranes made with both SDS and TEA were tested because these additives had a clear positive effect on the permeance (membrane 4 of example 3 and one new membrane).

The filtration characteristics after filtration with 1 g/L NaCl in milliQ-water are summarized in Table 5.

TABLE 5

| | | | Permeance | |
|---|---|---|---|---|
| | | Pressure | (L(m² h | Retention |
| Nr. | Membrane | (bar) | bar)) | (%) |
| 1 | BMIM Tf₂N-0.1 wt % MPD- | 30 | 1.08 | 42 |
| | 0.5 wt % TMC-no additives | | | |
| 2 | BMIM Tf₂N-0.1 wt % MPD- | 30 | 0.93 | 52 |
| | 0.5 wt % TMC-SDS and TEA | | | |
| 3 | Hexane-2.0 wt % MPD- | 30 | 1.78 | 94 |
| | 0.1 wt % TMC-SDS and TEA | | | |
| 4 | Hexane 0.1 wt % MPD- | 30 | 1.42 | 82 |
| | 0.5 wt % TMC-SDS and TEA | | | |

### Example 5

A polymer dope solution was prepared by dissolving 14 wt % PI (Matrimid® 9725 US, Huntsman) in NMP (Acros)/THF (Sigma Aldrich) with weight ratio 3/1 until complete dissolution. The viscous polymer solution was allowed to stand for several hours to remove air bubbles. The dope solution was then cast onto a porous non-woven PP/PE supporting substrate (Novatexx 2471, Freudenberg) with a casting speed of 0.044 m/s. After casting, an evaporation time of 30 s was used to vaporize part of the THF before immersing the films in a coagulation medium for 5 min. The coagulation medium consisted of HDA and MPD dissolved in milliQ water, in which HDA acts as a crosslinker for the PI film and MPD acts as a multifunctional amine monomer for IFP. Four PI support membranes were made via this method. The first film was immersed in a coagulation medium with a MPD-concentration of 0.1 wt %. The three other films were immersed in a coagulation medium with a MPD-concentration of 0.6 wt %.

After phase inversion, crosslinking of the support layer and impregnation with the amine monomer in the coagulation medium, two TFC membranes were made on the PI support membranes through IFP. Therefore, the PI support membrane was fixed on an inox plate and excess amine solution was removed with a rubber wiper. A glass frame was clamped (leakproof) on the PI support membrane. A solution of 0.5 wt % TMC in BMPy Tf2N was poured on the first PI support membrane. A solution of 3.0 wt % TMC in BMPy Tf₂N was poured on the second PI support membrane. After 1 min of reaction, the TMC solution was removed and the membrane was rinsed with ACN to remove residual TMC on the membrane surface. The resulting TFC membranes were stored in water until use. A liquid of pure BMPy Tf₂N was poured on the third PI support membrane to check the effect of the ionic liquid on the support membrane performance. After 1 min, the ionic liquid was removed and the membrane was rinsed with ACN and stored in water. The fourth PI support membrane was tested as such after storage in water.

The filtration characteristics after filtration with 35 μM RB in EtOH are summarized in Table 6.

TABLE 6

| | | | Permeance | |
|---|---|---|---|---|
| | | Pressure | (L(m² h | Retention |
| Nr. | Membrane | (bar) | bar)) | (%) |
| 1 | PI support membrane | 1 | 189.53 | 21 |
| 2 | PI support membrane after | 1 | 151.90 | 33 |
| | contact with BMPy Tf₂N | | | |
| 3 | BMPy Tf₂N-0.1 wt % MPD- | 30 | 0.64 | 99 |
| | 0.5 wt % TMC | | | |
| 4 | BMPy Tf₂N-0.6% MPD- | 30 | 0.55 | 99 |
| | 3.0 wt % TMC | | | |

Contacting the PI support membrane with BMPy Tf₂N has very little influence on the density of the support membrane. It is clear that a good top layer is present on membrane 3 and 4 since they show a very good performance.

### Example 6

A polymer dope solution was prepared by dissolving 18 wt % PSf (Udel® P-1700, Solvay) in NMP (Acros) until complete dissolution. The viscous polymer solution was allowed to stand for several hours to remove air bubbles. The dope solution was then cast onto a porous non-woven PP/PE supporting substrate (Novatexx 2471, Freudenberg) with a casting speed of 0.044 m/s. The cast films were immersed in a coagulation medium for 5 min. The coagulation medium consisted of milliQ water. Four PSf support membranes were made via this method. After phase inversion, two support membranes were impregnated with the amine monomer. Therefore, each PSf support membrane was fixed on an inox plate and water droplets on the surface were removed. A glass frame was clamped (leakproof) on the PSf support membrane. A solution of 2 wt % MPD in EMIM EtSO₄ was poured on the first PSf support membrane. A solution of 2 wt % MPD in EMIM EtSO_{4/}water (50/50 v/v) was poured on the second PSf support membrane. After 30 min, the excess MPD solution was removed. A liquid of pure EMIM EtSO₄ was poured on the third PSf support membrane to check the effect of the ionic liquid on the support membrane performance. After 30 min, the ionic liquid was removed and the membrane was stored in water. The fourth PSf support membrane was tested as such after storage in water.

After impregnation of the PSf support membrane with the amine monomer, TFC membranes were made on the first and second PSf support membranes through IFP. Therefore, each PSf support membrane was fixed on an inox plate and excess amine solution was removed. A glass frame was clamped (leakproof) on the PSf support membrane. A solution of 0.1 wt % TMC in hexane was poured on the PSf support membrane. After 10 min of reaction, the TMC solution was removed and the membrane was rinsed with hexane to remove residual TMC on the membrane surface. The resulting TFC membrane was stored in water until use.

The filtration characteristics after filtration with 35 μM RB in EtOH are summarized in Table 7.

TABLE 7

| | | | Permeance | |
|---|---|---|---|---|
| | | Pressure | (L(m² h | Retention |
| Nr. | Membrane | (bar) | bar)) | (%) |
| 1 | PSf support membrane | 1 | 193.72 | 5 |
| 2 | PSf support membrane after | 1 | 141.39 | 31 |
| | contact with EMIM EtSO₄ | | | |
| 3 | EMIM EtSO₄-2.0 wt % MPD- | 30 | 0.83 | 90 |
| | 0.1 wt % TMC | | | |
| 4 | EMIM EtSO₄/water (50/50)- | 30 | 0.45 | 92 |
| | 2.0 wt % MPD-0.1 wt % TMC | | | |

When membrane 1 and 2 are compared, it can be seen that contacting the PSf support membrane has an influence on the density of the support membrane, as can be derived from the decrease in permeance and increase in retention. Although this effect is rather small. A good top layer is present on membrane 3 and 4.

### Example 7

Membranes were prepared using the same method as described in example 5, with the only difference that impregnation with the amine monomer is performed with a solution of MPD in EMIM Ac.

The filtration characteristics after filtration with 35 MM RB in EtOH are summarized in Table 8.

TABLE 8

| | | | Permeance | |
|---|---|---|---|---|
| | | Pressure | (L(m² h | Retention |
| Nr. | Membrane | (bar) | bar)) | (%) |
| 1 | PSf support membrane | 1 | 221.02 | 10 |
| 2 | PSf support membrane after | 1 | 58.66 | 62 |
| | contact with EMIM EtSO₄ | | | |
| 3 | EMIM Ac-2.0 wt % MPD- | 30 | 0.35 | 90 |
| | 0.1 wt % TMC | | | |
| 4 | EMIM Ac/water (50/50)- | 30 | 0.33 | 82 |
| | 2.0 wt % MPD-0.1 wt % TMC | | | |

When membrane 1 and 2 are compared, it can be seen that contacting the PSf support membrane with EMIM Ac has a bigger influence on the density of the support membrane than contacting the support membrane with EMIM EtSO₄ (example 6). A good top layer is present on membrane 3.

1.-20. (canceled)

21. A method for preparing a thin film composite membrane having a top layer comprising a polyamide film, wherein the method comprises:
i. providing a porous support membrane impregnated with a first solvent comprising either solubilized multifunctional amines or solubilized acyl halides; and
ii. contacting the impregnated support with a second solvent, which is immiscible with the first solvent and which comprises either (a) solubilized multifunctional amines in case the first solvent comprises acyl halides or (b) solubilized acyl halides in case t first solvent comprises multifunctional amines, whereby the multifunctional amines and acyl halides interfacially polymerize to form the polyamide film;
wherein the first and/or the second solvent is an ionic liquid.

22. The method according to claim 21, wherein the first solvent comprises solubilized multifunctional amines and the second solvent comprises acyl halides.

23. The method according to claim 21, wherein the impregnated porous support membrane is contacted with the second solvent in (ii) by contacting a surface of the support membrane in the second solvent.

24. The method according to claim 21, wherein the impregnated porous support membrane comprises a crosslinked or non-crosslinked polymer.

25. The method according to claim 21, wherein the acyl halides comprise acyl chlorides.

26. The method according to claim 25, wherein the acyl chlorides are diacyl chlorides or polyacyl chlorides.

27. The method according to claim 21, wherein the multifunctional amines are selected from the group consisting of 1,2-diaminoethane, 1,3-diaminopropane, diaminobutane, diaminopentane, diaminohexane, diaminoheptane, diamino-octane, diaminononane, diaminodecane, ethylenediamine, N,N′-dimethylethylenediamine, N,N′-diethylethylenediamine, diethylenetriamine, triethylenetetraamine, tetraethylenepentaamine, pentaethylenehexamine, tris(2-aminoethyl)amine, polyethyleneimine, polyallylamine, polyvinylamine, polyether diamines based predominantly on a polyethylene oxide backbone with a molecular weight of 50 to 20,000, trimethoxysilylpropyl-substituted polyethyleneamine having a molecular weight of 1,000 to 200,000, m-xylylenediamine, p-xylylenediamine, multifunctional aniline derivatives, phenylenediamines, methylenedianiline, oxydianiline, and analogues thereof.

28. The method according to claim 21, wherein the first solvent is an aqueous solvent comprising solubilized multifunctional amines and the second solvent is an ionic liquid comprising solubilized acyl halides.

29. The method according to claim 28, wherein the second solvent is a hydrophobic, water immiscible ionic liquid.

30. The method according to claim 28, wherein the second solvent is an ionic liquid comprising bis(trifluoromethylsulfonyl)imide or hexafluorophosphate as anion and an imidazolium, pyrridinium, pyrrolidinium and phosphonium cation as cation.

31. The method according to claim 21, wherein the first solvent is an ionic liquid comprising solubilized multifunctional amines and the second solvent is an organic solvent or an ionic liquid comprising solubilized acyl halides.

32. The method according to claim 31, wherein the first solvent is a hydrophilic, water miscible ionic liquid.

33. The method according to claim 31, wherein the first solvent is an ionic liquid comprising acetate, alkyl sulfate, dialkyl phosphate or a halide as anion and a imidazolium, pyrridinium, pyrrolidinium and phosphonium cation as cation.

34. The method according to claim 31, wherein the second solvent is a hydrophobic, water immiscible ionic liquid.

35. The method according to claim 31, wherein the second solvent is an ionic liquid comprising bis(trifluoromethylsulfonyl)imide or hexafluorophosphate as anion and an imidazolium, pyrridinium, pyrrolidinium and phosphonium cation as cation.

36. A thin film composite membrane prepared by the method according to claim 21.

37. A method for the nanofiltration of components on thin film composite membrane having a top layer comprising a polyamide film comprising applying a liquid comprising components on the thin film composite membrane, wherein the membrane is prepared by a method comprising:
i. providing a porous support membrane impregnated with a first solvent comprising either solubilized multifunctional amines or solubilized acyl halides; and
ii. contacting the impregnated support with a second solvent, which is immiscible with the first solvent and which comprises either (a) solubilized multifunctional amines in case the first solvent comprises acyl halides or (b) solubilized acyl halides in case the first solvent comprises multifunctional amines, whereby the multifunctional amines and acyl halides interfacially polymerize to form the polyamide film,
whereby the first and/or the second solvent is an ionic liquid.

38. The method of nanofiltration according to claim 37, wherein the liquid is water.

39. The method of nanofiltration according to claim 37, wherein the liquid is an organic solvent.

40. The method of nanofiltration according to claim 37, wherein the liquid is a polar aprotic solvent.
